(19) United States
(12) Patent Application Publication
(10) Pub. No.: US 2014/0205982 A1
(43) Pub. Date: Jul. 24, 2014

(54) METHOD OF TREATMENT FOR PERSONS WITH ADDICTIONS

(71) Applicant: Jim Gray, Tees (CA)

(72) Inventor: Jim Gray, Tees (CA)

(21) Appl. No.: 14/160,373

(22) Filed: Jan. 21, 2014

Related U.S. Application Data
(60) Provisional application No. 61/755,574, filed on Jan. 23, 2013.

(30) Foreign Application Priority Data
Jan. 23, 2013 (CA) 2804428

(51) Int. Cl. G09B 23/28

(52) U.S. Cl. CPC G09B 23/28
USPC 434/262

(57) ABSTRACT

A method of treatment for persons with addictions. A first step of the method involves providing every person entering a treatment facility for treatment of an addiction with a tablet computer. A second step of the method involves using the tablet computer as a teaching aid containing course materials during classes and counselling sessions at the treatment facility. A third step involves using the tablet computer for storing support aids, monitoring by counsellors, communicating with counsellors, and communicating with a peer support network when the person is not in classes and counselling sessions at the treatment facility. A fourth step involves continuing to use the tablet computer for storing support aids, monitoring by counsellors, and communicating with the peer support network after the person leaves the treatment facility to resume his or her life outside of the treatment facility.

### FIELD

There is described a method of treatment for persons with addictions.

### BACKGROUND

A major problem facing treatment programs for persons with addictions at treatment facilities is an unacceptable rate of relapse. Approximately 75% to 80% of those treated relapse and must return to the treatment facility for further treatment within 2 years. What is required is a method of treatment which will reduce the rate of relapse.

### SUMMARY

There is provided a method of treatment for persons with addictions. A first step of the method involves providing every person entering a treatment facility for treatment of an addiction with a tablet computer. A second step of the method involves using the tablet computer as a teaching aid containing course materials during classes and counselling sessions at the treatment facility. A third step involves using the tablet computer for storing support aids, monitoring by counsellors, communicating with counsellors, and communicating with a peer support network when the person is not in classes and counselling sessions at the treatment facility. A fourth step involves continuing to use the tablet computer for storing support aids, monitoring by counsellors, and communicating with the peer support network after the person leaves the treatment facility to resume his or her life outside of the treatment facility.

With the above described method, the tablet computer is allowed to become a crutch for the person with an addiction. He or she comes to rely upon the tablet computer during the period of his or her stay at the treatment facility. Addiction counsellors and peer support are available during classes and counselling sessions at the treatment facility. However, the time spent in classes and counselling sessions is only a very small percentage of the time spent at the treatment facility. The evening hours can be particularly long, as there are no other activities to keep the person with an addiction occupied. When the person with an addiction is not in classes and counselling sessions, addiction counsellors and peer support are accessed through the tablet computer. There is no time limited for the peer support, which is available 24 hours a day. When the person with an addiction must return to their home and work environment, the tablet computer goes with them. The person with an addiction continues to access addiction counsellors and peer support, as he or she did at the treatment facility. The intention is to make communication outside the treatment facility an extension of the communication that existed within the treatment facility. With this approach, the tablet computer is used by the person with an addiction to avoid falling back into their addiction, as will hereinafter be described.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a diagram depicting communication within an addiction treatment facility in accordance with the present method.

FIG. 2 is a diagram depicting communication outside of the treatment facility once the person goes home and must return to work in his or her community.

### DETAILED DESCRIPTION

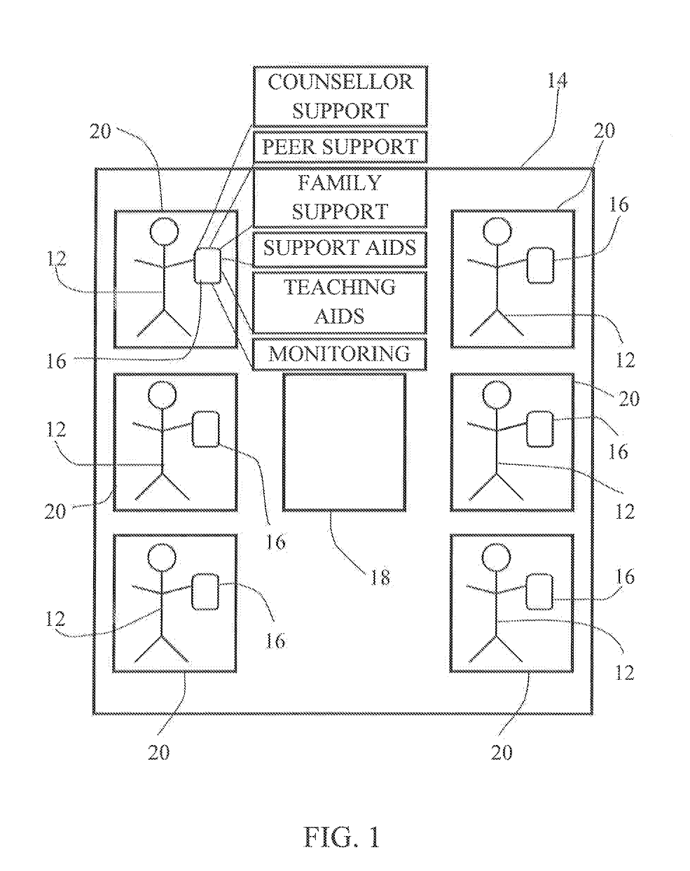

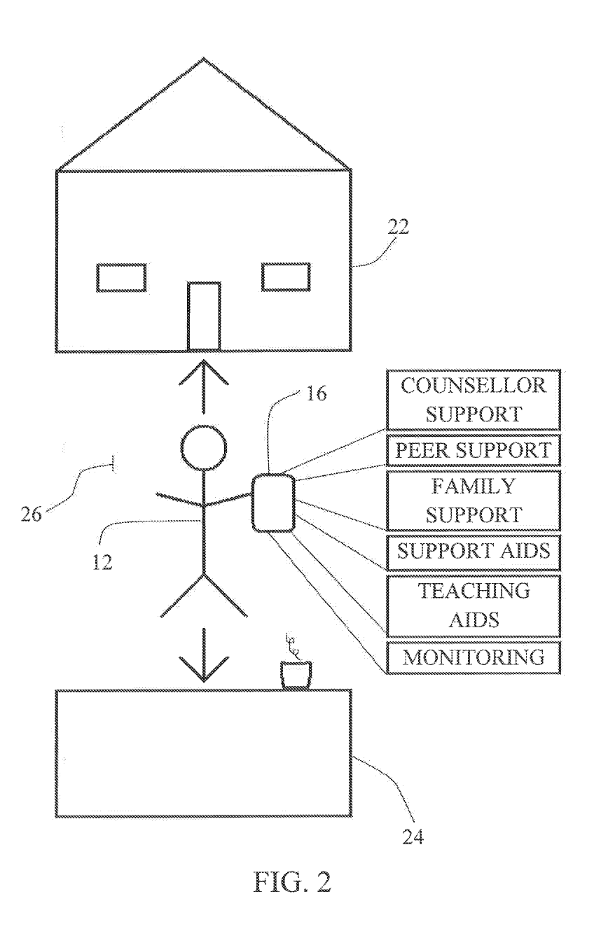

A method of treatment for persons with addictions will now be described with reference to FIG. 1 and FIG. 2.

### The Method:

Referring to FIG. 1, a first step of the method involves providing every person 12 entering a treatment facility 14 for treatment of an addiction with a tablet computer 16. A second step of the method involves using tablet computer 16 as a teaching aid containing course materials during classes and counselling sessions that take place in a classroom 18 at treatment facility 14. A third step involves using tablet computer 16 for storing support aids, monitoring by counsellors, communicating with counsellors, and communicating with a peer support network when person 12 is not in classes and counselling sessions at treatment facility 14. It will be appreciated that most of the time, person 12 will be in their room 20, when not in classes and counselling sessions. Referring to FIG. 2, a fourth step involves continuing to use tablet computer 16 for storing support aids, monitoring by counsellors, and communicating with the peer support network after the person leaves the treatment facility to resume his or her life outside of the treatment facility. It will be appreciated that person 12 will be spending most of his or her time at home 22 or work 24, with some time spent in their community 26 outside of home 22 and work 24.

The time that will be hardest for person 12, while inside treatment facility 14 or after leaving treatment facility 14 is the time spent alone. When alone, there will be a strong urge to return to the previous patterns of behaviour that manifested itself in an addiction to alcohol, drugs or some other activity. During those desperate times, person 12 must use those support aids at his or her disposal to avoid a return to the addiction. The supports aids include course materials, so that person 12 can quickly search and review course materials relevant to their current crisis to reinforce what he or she should do. The support aids include a progress log, so person 12 can review the progress log, to reinforce how far he or she has come and resist sliding back into addiction. This progress log will include such things as weekly pictures. For a person with an alcohol or drug addiction, the pictures will show a steady climb from a dishevelled look to a well groomed and healthier appearance. For a party with a food addiction, the pictures may show dramatic weight loss. The support aids will include pictures and notes regarding those things in life that person 12 holds near and dear. This will usually include pictures and letters of encouragement from family and friends. This will also include pictures and notes regarding interests, which may vary from guitar, to classic cars, to boats, to botany. If the support aids alone are not of assistance, person 12 may try to communicate via tablet computer 16 with his or her counsellor. Unfortunately, counsellors are unable to make themselves available 24 hours a day, 7 days week. If the counsellor is not available, person 12 still must obtain the support necessary to get through the immediate crisis. This may just be getting through the rest of the evening, until it is time to go to work. The peer support network is accessible via table computer 16 24 hours a day, 7 days a week.

Benefits Derived from the Method:

Teaching—For most persons with addictions the tablet computer is a novelty, which assists in getting them interested in and committed to the program. The technology is relatively simple, and a high degree of computer literacy is not required. The person with an addiction is able to place all of his or her course materials on the tablet computer. A record of all medications can be maintained on the tablet computer. The tablet computer can provide alerts to the person with the addiction as to when medications should be taken. These medication alerts minimize the risk of accidental overdoses or missed medications. The tablet computers can be integrated with smart boards to enable persons with addictions to benefit from educational content that a facilitator places on the smart board.

Journaling—An important part of the counselling program is to have the person with an addiction keep a daily journal. The person with an addiction writes down what he is thinking and feeling. The writing down is therapeutic. The person with an addiction sends the journal entries to his or her counsellor on a daily basis. The counsellor carefully reviews those entries to determine the state of mind of the person with an addiction. Some journal entries may trigger an immediate visit from the counsellor, such as entries that speak of suicide.

Monitoring—There are various “face to face” communication modes that can be employed with a tablet computer, such as SKYPE®. A person can indicate to their addiction counsellor that they are doing fine, but their image and the background image of their surroundings may indicate that the contrary is true. Medication alerts, described above, can concurrently be sent to addiction counsellors to allow monitoring of medications. Scanning capabilities of the tablet computers allow addiction counsellors to log attendance at groups and attendance at a dining hall to track persons with eating disorders and ensure that basic nutritional requirements are being met. Strengths and weaknesses of each person with an addiction can be assessed and compared to persons who have relapsed, this enables addiction counsellors to anticipate and take preventative action before a relapse occurs.

Peer Support—When the person with an addiction is on the verge of having a relapse, peer support is critical. The tablet computer provides access through the internet to a peer support network 24 hours a day, 7 days a week. This can be in the form of a duty roster of addiction counsellors, but can also be provided by fellow addicts who are struggling with the same addiction and enduring the same problems. Peer support is of particular importance to persons working in remote work camps. Drinking is often an acceptable recreational activity for workers at remote work camps. Working at such remote work camps and participating in recreational drinking, is often the way the person with an addiction became addicted in the first place. When they return to the remote work camps, where others are engaged in drinking, it can be critically important for the person with an addiction to withdraw to their quarters and seek support from his or her peer support network until the urge to join in the drinking activity subsides.

Family Support—It has been found that having all pertinent information on the tablet computer assists the person with an addiction in showing their spouse and other family members what they are doing in the program. This helps get the family onside to provide the support and encouragement needed. It also helps alert the family member when it becomes apparent that the person with an addiction is not doing what the program calls for. Tablet computer 16 can provide a communication link to family members, when person 12 is in the treatment facility or when person 12 is working at a distance from home.

Support Aids—When the person with an addiction is on the verge of having a relapse, the person is able to rapidly search his or her course materials to obtain instant access of specified sections of the course materials that are pertinent to the crisis threatening to cause the relapse. The person with an addiction is able to use pictures taken week by week to monitor their progress, which helps keep them motivated and inspired. The person can also keep pictures of their spouse, children, pets, etc., close at hand to help them bridge difficult times when they are urged to relapse.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of treatment for persons with addictions, comprising:
providing every person entering a treatment facility for treatment of an addiction with a tablet computer;
using the tablet computer as a teaching aid containing course materials during classes and counselling sessions at the treatment facility;
using the tablet computer for storing support aids, monitoring by counsellors, communicating with counsellors, and communicating with a peer support network when the person is not in classes and counselling sessions at the treatment facility; and
continuing to use the tablet computer for storing support aids, monitoring by counsellors, and communicating with the peer support network after the person leaves the treatment facility to resume his or her life outside of the treatment facility.
